(19) United States
(12) Patent Application Publication
(10) Pub. No.: US 2026/0096954 A1
(43) Pub. Date: Apr. 9, 2026

(54) TASK REMINDER DEVICE

(71) Applicant: PilLogic, LLC, Inman, SC (US)

(72) Inventors: Christine Hildebrandt, Inman, SC (US); William Hildebrandt, Inman, SC (US)

(73) Assignee: PilLogic, LLC, Inman, SC (US)

(21) Appl. No.: 19/351,395

(22) Filed: Oct. 7, 2025

Related U.S. Application Data
(60) Provisional application No. 63/704,746, filed on Oct. 8, 2024.

(51) Int. Cl. A61J 7/04

(52) U.S. Cl. CPC A61J 7/0481

(57) ABSTRACT

The present invention relates to a task reminder for attachment to a medication dispenser that includes a movable pointer part of which is disposed in a housing. When a dose of medication is taken, the user moves the pointer within labeled channels that indicate the day and time the dose has been administered. The act of manually recording the day and time of the dose on the device helps to create a more complete memory of the medication administration event. When the user or caregiver returns to consider administration of a subsequent dose, inspection of the stylus position indicates the approximate time of the last dose. This information along with the dosing directions on the original dispensing label allows the user added safety and confidence with the decision regarding the current dose.

### BACKGROUND OF THE INVENTION

### 1) Field of the Invention

The present invention relates to a task reminder apparatus that may be used to remind the user of various tasks that must be repeated on a periodic and/or recurring basis. One such task is medication administration. In at least one embodiment, the device attaches to an existing medication container. Physical manipulation of an indicator stylus or pointer within a closed course of labeled positions is used to record the day of the week and the time of day a particular medication dose is administered. Information thus recorded along with administration frequency instructions on the original dispensing label enable the user to determine the appropriateness of subsequent doses. While the description of the device is primarily limited to use with dispensing of medication, the device can also be used to remind a user whether a variety of periodic or regularly recurring tasks have been completed.

### 2) Description of Related Art

The present invention relates generally to timers and recorders that serve as a record of previously administered medication doses and that can be a affixed to original pharmacy or manufacturer medication containers for outpatient use to improve medication adherence.

A majority of people in developed countries take one or more outpatient medications one or more times daily in the form of prescriptions, vitamins, and other supplements. Additionally, many people have pets in their homes that also require medications. Acute conditions may require pharmaceutical treatments over a period of days or weeks, but chronic diseases often require a lifetime of drug therapy.

The therapeutic goals of these medications are best attained when the medications are taken according to administration instructions from a healthcare professional as labeled on the original dispensing container. For a wide variety of reasons, patients are often unintentionally non-adherent with labeled directions for use. Too many or too few doses are often given resulting in toxicity in the first instance or lack of efficacy in the latter. The most common cause of unintentional non-adherence of medications used to manage chronic conditions is forgetfulness. Over time, the act of taking a maintenance medication in the home setting becomes a non-event in a day filled with normal routines and unscheduled distractions. Additionally, many chronic conditions are free of short-term symptoms and do not render clues that a dose has been missed. Missing doses can have long term negative consequences. In short, unintentional medication non-adherence is common, dangerous, and costly to both the individual and the health care system.

Many solutions with a goal of optimizing medication adherence in the home setting can be found in prior art. Most of these proposed solutions along with their shortcomings fit into the following general categories.

### First—Charting in a Written Log

In hospital and other institutional settings, medication administration is recorded either electronically or manually on a patient's Medication Administration Record (MAR). MARs are not generally available for home use, but separate manual charting of administered doses is sometimes undertaken by patients or their caregivers as a solution for unintentional non-adherence. Formatting, utilization, and storage of home prepared MARs all present significant problems for both patients and in-home caregivers.

### Second—Repackaging in Pill Organizers or Other Replacement Packaging

Any product that requires the user to remove the medication from federally mandated packaging is inherently dangerous. These products include pill organizers, weekly medication cassettes, and replacement containers with attached timing devices. All of these products may result in one or more of the following problems: errors during repackaging, loss of original labeling, loss of legal packaging, and loss of physical and chemical protection provided by the original dispenser packaging.

### Third—Timing Devices That Replace the Original Closure Cap

Some timing devices have been disclosed that replace the original lid, while retaining the original bottle or vial that was provided with the original dispensing. This again may alter the physical and chemical protection provided by the original container. Additionally, replacement of the original lid or cap necessitates that the timing device be manufactured in a vast array of configurations and sizes to fit the multitude of container mouths currently available in the marketplace.

### Fourth—Medication Administration Alarms

These solutions include a variety of medication administration alarms, beepers, watch alarms, programmed phone calls, and mobile phone apps. Many of these alarm type solutions are not useful when multiple medications are being used. Another problem is that the patient, the medication, and the alarm may not be in the same place when the alarm sounds. Many of these types of devices require programming and additional setup that may be di ﬃcult for seniors and other users.

### Fifth—Reminders for Liquid Medicines

Bottles and closures for liquid medicines are different than those found on containers of solid dosage forms, such as vials. Patients needing liquid medicines are typically children, disabled, or elderly. Many of these patients have multiple caregivers who need easily accessible information regarding previous dosing. Most of the prior art medication reminders cannot be readily adapted to liquid medicine containers.

### Sixth—Adjustable Dose Recorder Labels

Examples of timer reminders for medication dispensers in the particular category of adjustable dose recorder labels are shown in the following references.

U.S. Pat. No. 6,152,067, issued to Mathison, on Nov. 28, 2000, is attached to a medication vial and has a pointer on a hub that can be moved relative to an underlying time of day indicia/indicator. A patient can rotate the dial about a hub to indicate the time at which the last dose of medication was taken or the time at which the next dose of medication is due. This device must be of a size large enough to be read and manipulated by the user and would therefore likely occlude instructions for use found on the original labeling. Additionally, use of this device is not self-evident.

U.S. Pat. No. 6,279,759, issued to Weisbach, on Aug. 28, 2001, is a medication record keeping apparatus that comprises a label or sheet with a plurality of characters identifying at least one subject upon which a friable removable mask covering obscures each of the characters. The label or sheet is adapted to be fixedly applied to a medication containing vessel wherein each time an individual unit of medication is consumed, the friable removable mask is removed from a character in order that the underlying subject will be exposed so that a visual record will be kept of the medication consumed. This device must be large enough to be usefully functional and would be difficult to apply to an existing medication container.

U.S. Pat. No. 6,796,267, issued to DuBarry, on Sep. 28, 2004, is a reusable device that provides tracking of task performance by multiple independently movable arms that record a complete cycle of use, usually one week, and can then be reset. This device would require storage of the original dispensing vessel in this product.

U.S. Pat. No. 7,614,358, issued to Duer, on Nov. 10, 2009, is a dosage reminder device comprising a front plate, a set of slides inserted into the front plate, and a connected back plate. Individual slides correspond to the days of the week. Each slide is movable within the assembly to a first position for a dosage not taken, a second position to indicate a dosage taken, or to a third position to indicate no dosage. The rear of the back plate has a removable adhesive cover that once removed, facilitates adhering the dosage reminder device to a medicine vial. Multiple daily doses require multiple recorder labels which can occlude administration directions and cause confusion for the user.

U.S. Pat. No. 9,142,148, issued to Stanton, on Sep. 22, 2015, shows a thermoplastic adjustable reminder label that is configured to indicate removal of content from a bottle to which said label is coupled. The label has a flanged thermoplastic knob extending above a rectangular flange with a longitudinal axis and a transverse axis perpendicular to the longitudinal axis. A pair of resilient units is coupled to the flange along transverse sides and extends beyond the transverse sides. Each resilient member terminates in protrusions to engage parallel grooves etched internally in each of longitudinal parallel walls of a housing. A flap is coupled by means of hinging to a housing base frame to frictionally engage the housing and form a floor. This device does not appear to have utility beyond single daily dosing regimens due to minimum size constraints.

The objectives of the present invention are therefore to provide a device to improve medication adherence in the outpatient setting that is easy to understand, simple to use, effective, economical, and that overcomes the limitations and deficiencies of prior art.

Another object of the present invention is to provide a device that can be used to easily remind user of when the last time a reoccurring task was completed. Another objective of the present invention is to add a simple step to the process of completing the task. The additional step in said process adds to the memory of said tracked event. This helps the user to recall when the last time a recurring task was completed. The user can verify the memory by inspection of the device and make an informed decision as to the timeliness for the next recurring task.

Another object of the present invention is to provide a device that is capable of semi-permanent attachment to receptacles or containers associated with the measured task. Said containers may include vessels with cylindrical or flat surfaces. Examples include prescription vials, bottles, boxes, and the like.

### SUMMARY OF THE INVENTION

The present invention relates to a task reminder device comprising a top plate having an upper surface and a lower surface and a perimeter side wall; a bottom plate having an upper surface and a lower surface wherein the upper surface of the bottom plate is adapted to be engaged by the perimeter side wall so that when the top plate is secured to the bottom plate, the upper surface fits within the perimeter side wall; a cavity formed between the upper surface of the bottom plate and the lower surface of the top plate when the top plate is secured to the bottom plate; a central channel disposed in the top plate and extending along a central axis; a moveable stylus having a handle that protrudes from the central channel and a flange that is disposed within the cavity; a plurality of slots formed in the top plate that extend perpendicularly from the central channel wherein each of the plurality of slots includes a left slot and a right slot, each of which are adapted to receive the stylus; a plurality of day indicators, each corresponding to one of the plurality of slots; a plurality of time indicators, each corresponding to the one of the plurality of slots, wherein the plurality of time indicators includes a first time indicator corresponding to the left slot and a second time indicator corresponding to the right slot; and an adhesive layer disposed on the lower surface of the bottom plate and having a radiused surface along a latitudinal axis, the radiused surface being adapted to engage and adhere to a curved surface. In one embodiment, the task reminding device comprises at least two adhesive strips that are disposed on the lower surface of the bottom plate so that the adhesive strips are parallel to one another and are adapted to engage and adhere to one of a curved and a flat surface.

In alternative embodiments, the task reminding device further comprises a plurality of tabs formed in the bottom plate, each of the plurality of tabs is capable of being depressed and further having an unengaged state where a top surface of the tab protrudes above the top surface of the bottom plate and an engaged state where the flange of the stylus is disposed between the tab and the lower surface of the top plate so that when the tab is in the engaged state, the top surface of the tab engages the flange of the stylus so that the top surface of the tab pushes the flange towards the lower surface of the upper plate, thus creating a resistance that inhibits movement of the stylus. In one embodiment, each of the plurality of tabs includes a distal end that extends above the upper surface of the bottom plate when the tab is in the unengaged state and is depressed by the stylus when in the engaged state. In one embodiment, the flange includes an indention that is adapted to receive the distal end of the tab when in the engaged state. In one embodiment, the upper surface of the bottom plate comprises a central flat portion, a first lateral portion and a second lateral portion, each of which is angled in relation to the central flat portion so that both the first and second latera portions extend downwardly from the central flat portion. In one embodiment the plurality of tabs are disposed on and/or formed in the flat central portion of the lower plate.

In a further embodiment, the task reminding device comprises A top surface, a bottom surface and at least one side wall interconnecting the top surface and bottom surface; a cavity formed between the top surface and the bottom surface; a central channel disposed in the top surface and extending along a central axis; a plurality of slots formed in the top plate that extend perpendicularly to the central channel wherein each of the plurality of slots includes a left slot and a right slot; a moveable stylus having a lower portion disposed within the cavity and upper portion that extends above the top surface, wherein the stylus is moveable between the central channel and the plurality of slots. In such an embodiment, a user may record the completion of a task by moving the stylus to a predetermined slot within the plurality of slots.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective view of an embodiment of the present invention.

FIG. 2 shows an exploded view of an embodiment of the present invention.

FIG. 3 shows a top plan view of an embodiment of the present invention during use.

FIG. 4 shows a perspective view of an embodiment of the present invention.

FIG. 5 shows and exploded view of an embodiment of the present invention.

### DETAILED DESCRIPTION OF A PREFERRED EMBODIMENT

With reference to the drawings, the invention will now be described in more detail. Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are herein described.

Unless specifically stated, terms and phrases used in this document, and variations thereof, unless otherwise expressly stated, should be construed as open ended as opposed to limiting. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Furthermore, although items, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternative embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits, and advantages will be apparent from the above in conjunction with the accompanying examples, data, figures and all reasonable inferences to be drawn therefrom, alone or with consideration of the references incorporated herein.

Without limiting the scope of the invention, a preferred embodiment with features is hereinafter set forth. All of the United States patents, which are cited in the specification, are hereby incorporated by reference.

Medicine containers may be generally described as prescription vials or bottles as dispensed by a pharmacy or veterinarian, manufacturer containers for the same, and other containers for OTC (over the counter) medicines, vitamins, supplements, and other items intended to be taken at preferred intervals of time.

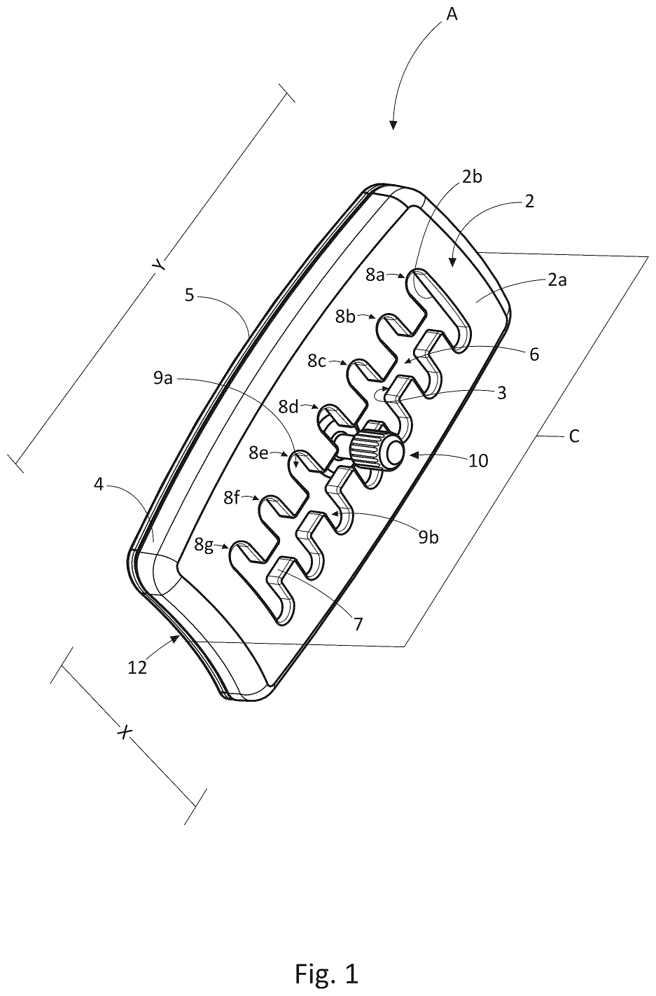

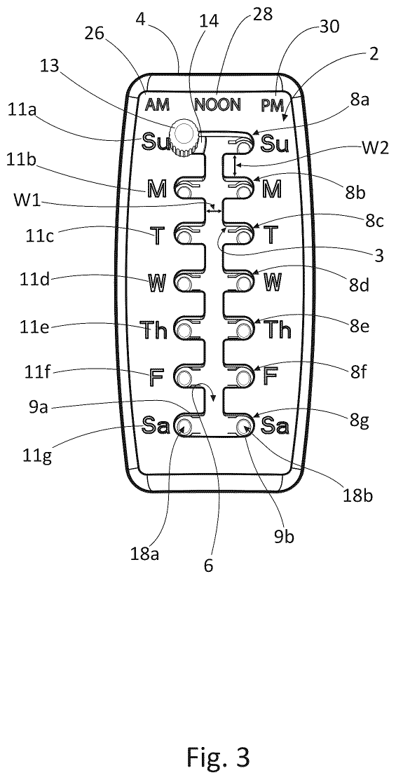

Referring to FIGS. 1-3, the present invention is shown generally as A. In one embodiment, the present invention includes an upper/top plate 2 having an upper surface 2a and a lower surface 2b and has sufficient thickness 7 to be generally rigid. A perimeter side wall 4 creates a cavity 3 between the lower surface 2b of the top plate 2 and the upper surface 5a of the lower/bottom plate 5. The top plate 2 includes a central channel 6 that extends lengthwise along a longitudinal axis Y. In at least one embodiment, the central channel 6 extends along a central axis C. The central channel 6 includes a plurality of slots 8a-8g that extend generally perpendicular to the central channel 6 and generally parallel to a latitudinal axis X. In one embodiment, the present invention includes seven side to side slots 8a-8g, one for each day of the week. In alternative embodiments, any number of side to side slots could be used. In the shown embodiment, each slot has a first side slot 9a and a corresponding second side slot 9b. The first side slot 9a extends perpendicularly from the central channel 6 in a first or left direction. The second side slot 9b extends perpendicularly from the central channel 6 in a second or right direction. As shown in FIG. 3 and discussed more fully below, the side slots 9a-9b may be labeled to correspond to the seven days of the week as well as AM, NOON and PM positions. The top plate 2 and bottom plate 5 are permanently or removably attached by mechanical or other means. A lower portion 14 of a movable stylus 10 is captured in the cavity 3 between the top plate 2 and bottom plate 5 while an upper portion 13 extends above the top plate 2. The stylus 10 can be positioned by the user to the aforementioned labeled positions as medication doses are administered. The assembled device includes an arc 12 along one or both of the latitudinal axis X and longitudinal axis Y to facilitate attachment to a curved surface such as a medicine container. In the shown embodiment, the lengthwise arc facilitates attachment via one or more adhesive strips to a medication container or other container.

The bottom plate 5 includes two opposing longitudinal ridges 16a-16b that are disposed on the upper surface 5a of the bottom plate 5. These longitudinal ridges extend along longitudinal axis Y and are laterally spaced from one another along the latitudinal axis X. These longitudinal ridges have a generally triangular cross sectional shape and form clips and/or snap locks that engage a lip or flange (not shown) that is disposed on the lower surface 2b of the top plate 2. In one embodiment, the dimensions of the lower plate 5 are selected so that the lower plate 5 may fit within the top plate 2 such that when secured to the upper plate, the bottom plate's upper surface 5a fits within the perimeter side wall 4 of the top plate 2 When the top plate 2 is pressed down over the bottom plate, the side wall 4 of the top plate 2 encompasses and/or surrounds the perimeter of the bottom plate's upper surface 5a so that the bottom plate's lower surface 5b is flush with the perimeter side wall 4. In alternative embodiments, the bottom plate 5 may extend beyond the perimeter side wall 4 when the top plate 2 and lower plate 5 are secured together. When the top plate engages the bottom plate, the longitudinal ridges 16a-16b, engage the lip and/or flange disposed on the lower surface 2b of the top plate 2 so as to secure the top plate 2 to the bottom plate 5 with the stylus 10 being captured in the cavity 3 formed between the upper and bottom plate. Alternate means of attaching the upper and bottom plates may be employed such as adhesive, screws, fasteners, clips, detents compression fittings or any other means generally known in the art.

A movable indicator stylus 10 is shown having a handle 13 and a lower retention skirt and/or flange 14 that is interconnected by a shaft 13b. This retention skirt/flange has a diameter that is greater than either the width W1 of the central channel 6 and/or the width W2 of any of the side-to-side slots 8a-8g, thereby preventing the stylus from being removed from between the top plate 2 and the bottom plate 5. As discussed below, the retention skirt also provides a surface against which one or more biased tabs 18a-b may press against the flange to hold the stylus in place. In the shown embodiment, the shaft 13b has a diameter or width that is less than the diameter and/or width of either the handle 13 and the flange 14 as well as being less than the width W1 of the central channel and the width W2 of the slots. This allows the stylus to be moved throughout the central channel and perpendicular slots while preventing the stylus from being able to be pushed completely into or out of the cavity 3. In at least one embodiment W1 and W2 are equal.

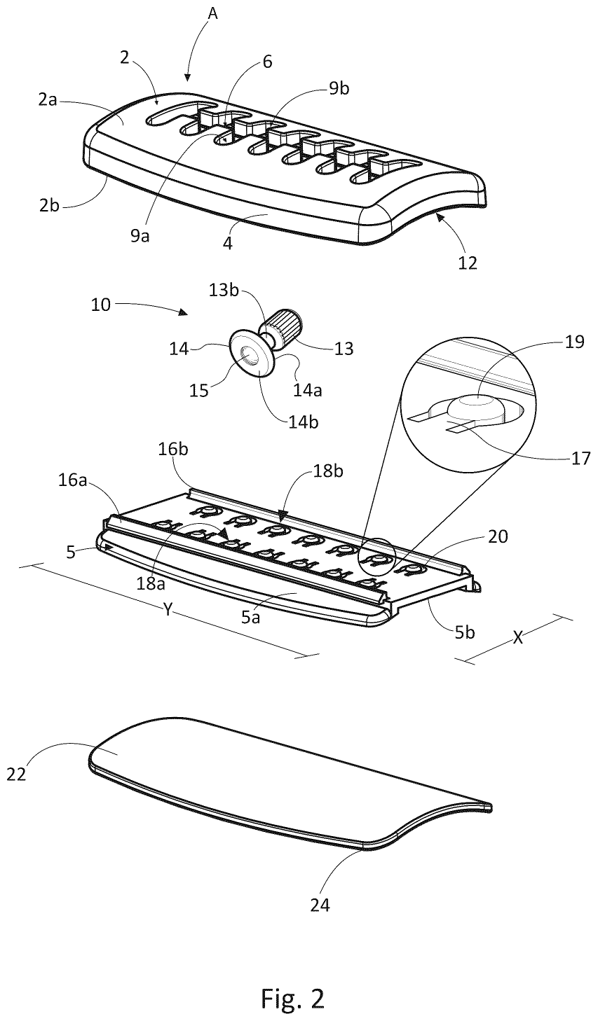

The bottom plate 5 includes a plurality of corresponding biased tabs 18a-18b that are formed by partial cut-outs 20 that follow at least a portion, but not the entirety of, the circumference or perimeter of the tab. In the shown embodiment, the tab 18a has a distal end 19 that protrudes above the upper surface 5a of the bottom plate 5 as well as a proximal end 17 that is integrally connected to the bottom plate so that the distal end 19 may be biasedly depressed when the stylus 10 is positioned over the tab, thus holding the stylus in place. The tab is placed in an engaged state when the stylus 10 is placed over the tab 18a so that the flange 14 of the stylus depresses the distal end 19 of the tab. Because the proximal end 17 of the tab is integral to the bottom plate 5, the tab's distal end 19 exerts an upward force on the stylus towards the lower surface 2b of the upper plate 2, thus creating resistance that holds the stylus in the engaged position. When the tab is in this engaged state, the top surface of the tab 18a and/or its distal end 19 engages the flange 14 so that the top surface and/or distal end of the tab pushes the flange towards the lower surface 2b of the upper plate, thus creating a resistance that inhibits movement of the stylus. This engaged state can be seen in FIG. 3 wherein the tab associated with Sunday morning (in the left slot of 8a) is in the engaged state. The tab also has an unengaged state where the stylus is positioned within one of the central channel 6 and/or the perpendicular slots 8a-g, such that the stylus is not over one of the tabs 18a-g and/or their distal ends 19. In FIG. 3, each of the remaining tabs (excluding the one associated with Sunday Morning) are in the unengaged state because the stylus has not been placed over any of them. Each of the tabs shown in FIG. 2 are in an unengaged state because the stylus is not in contact with any of the tabs. The flange 14 of the stylus has an upper surface 14a and a lower surface 14b. In one embodiment, the lower surface 14b include an indentation 15 that is adapted to engage the tab's distal end 19 when the stylus is located over the tab to place the tab into the engaged state. Alternatively, the flange could include a protrusion that is adapted to be engaged by a corresponding indention (not shown) on the tab's distal end 19 and to press down on the distal end when in an engaged position.

In the embodiment shown, each side-to-side slot 8a-8g includes an opposing pair of biased tabs 18a-18b that correspond to the first and second side slots 9a-9b. Once the top plate and bottom plates are secured together, the biased tabs gently hold the stylus 10 within one of the first and second side slots 9a-9b via a mechanical bias when in an engaged state. In an alternate embodiment, each set of biased tabs could include a third biased tab located between the first and second biased tabs 18a-18b, thus providing a mechanical bias to gently hold the stylus 10 within the central slot. In this embodiment, the present invention could include three reminder times, morning, noon, and night, where morning is indicated by placing the stylus in the first side slot 9a, noon is indicated by placing the stylus in the central channel 6 and night is indicated by placing the stylus in the second side slot 9b.

The components of the device comprising the top plate 2, bottom plate 5, and the stylus 10, may be formed of the same or different materials. Examples of suitable materials include acrylonitrile butadiene styrene (ABS), polyurethane, polyvinyl chloride, in particular, high density and ultra-high molecular weight polyethylene, and propylene/ethylene copolymers. The parts may be formed by injection molding or milling, or a combination of injection molding and milling. In an alternative embodiment, the top plate and bottom plate could be replaced with a housing formed of one piece of material having a top surface and a bottom surface that form a cavity in which the stylus may be housed.

In one embodiment, the lower surface 5b of the bottom plate 5 may be provided with a pressure sensitive adhesive layer 22 disposed on one or more locations of the lower surface such as along one or more of the edges of the lower surface. One side of the adhesive layer may be bonded to the bottom plate's lower surface 5b and the other side is tacky, and may be covered by a releasable film 24, which can be easily removed before the tacky side of the adhesive layer is pressed against the side of the medication container. The adhesive layer may contain a stratum of foam, positioned between the underside of the lower plate and the tacky side of the adhesive layer so that the last dose reminder may better fit medication containers with circumferences that are not an exact match to the widthwise arc of this device.

Referring to FIG. 3, a plurality of day indicators 11a-11g may be disposed on the top plate 2 so that they correspond to each set of side to side slots 8a-8g. In the shown embodiment, these day indicators 11a-11g represent the day on which the task (e.g., medication administration) was accomplished. The invention may further include a set of time indicators 26, 28 and 30 that may be disposed at the top or bottom of the top plate 2 and positioned such that an AM indicator 26 is associated with and/or corresponds to the left side slot 11a, a PM indicator 30 associated with and/or corresponds to the right side slot 11b, and a noon indicator 28 is associated with and/or corresponds to the central channel 6. In the shown embodiment, the present invention shows that the last time that the task was performed was Sunday morning. When the task is performed at noon, the stylus 10 may be moved to the central channel 6 under the noon indicator. When the task is performed at night, the stylus may be moved to the right side slot 11b under the PM indicator. Once the task is performed on Monday morning, the stylus may be moved down to the second side to side slot 8b and placed in the left side slot 9b which is associated with the AM indicator 11b for Monday.

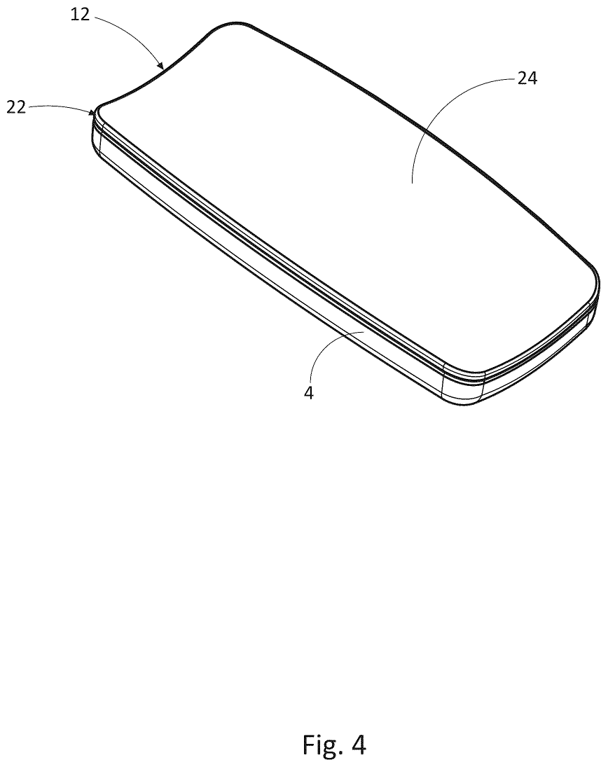

Referring to FIG. 4, a perspective bottom view of the present invention is shown. The widthwise arc 12 is shown as is a portion of the perimeter side wall 4. The foam layer of the pressure sensitive adhesive layer 22 is covered by a releasable film 24. Once the film is removed the adhesive layer may be used to secure the device to a medication container such as a pill bottle.

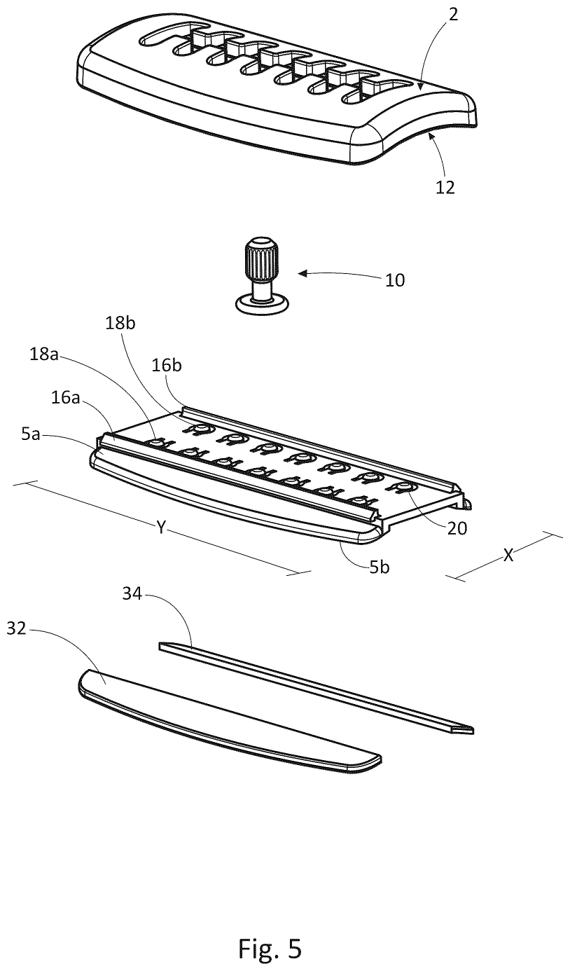

Referring now to FIG. 5, another embodiment may utilize adhesive strips 32 and 34 disposed along the longitudinal axis Y, along the perimeter of the lower plate or in any arrangement deemed advantageous for securing the device to a flat and/or radiused surface.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art using the teachings disclosed herein.

What is claimed is:

1. A task reminding device comprising:
A top plate having an upper surface and a lower surface and a perimeter side wall having an inner surface and an outer surface;
A bottom plate having an upper surface and a lower surface wherein the bottom plate is adapted to be engaged by the top plate so that when the top plate is secured to the bottom plate, the upper surface of the bottom plate fits within the perimeter side wall;
A cavity formed between the upper surface of the bottom plate and the lower surface of the top plate when the top plate is secured to the bottom plate;
A central channel disposed in the top plate and extending along a central axis;
A moveable stylus having a lower flange disposed within the cavity and upper portion that extends above the top plate;
A plurality of slots formed in the top plate that extend perpendicularly to the central channel wherein each of the plurality of slots includes a left slot and a right slot, each of which are adapted to receive the stylus;
A plurality of day indicators, each corresponding to one of the plurality of slots; and,
A plurality of time indicators, each corresponding to the one of the plurality of slots, wherein the plurality of time indicators includes a first time indicator corresponding to the left slot and a second time indicator corresponding to the right slot.

2. The device of claim 1 further comprising a plurality of tabs formed in the bottom plate, each of the plurality of tabs is capable of being depressed and further having an unengaged state where a top surface of the tab protrudes above the top surface of the bottom plate and an engaged state where the flange of the stylus is disposed between the tab and the lower surface of the top plate so that when the tab is in the engaged state, the top surface of the tab engages the flange of the stylus so that the top surface of the tab pushes the flange towards the lower surface of the upper plate, thus creating a resistance that inhibits movement of the stylus.

3. The device of claim 2 wherein each of the plurality of tabs includes a distal end that extends above the upper surface of the bottom plate when the tab is in the unengaged state and is depressed by the stylus when in the engaged state.

4. The device of claim 3 wherein the flange includes an indention that is adapted to receive the distal end of the tab when in the engaged state.

5. The device of claim 1 further including an adhesive layer disposed on the lower surface of the bottom plate.

6. The device of claim 5 wherein the adhesive layer has a radiused surface and is adapted to engage and adhere to a curved surface.

7. The device of claim 5 wherein the adhesive layer comprises at least two adhesive strips that are disposed on the lower surface of the bottom plate so that the adhesive strips are parallel to one another and are adapted to engage and adhere to one of a curved and a flat surface.

8. The device of claim 1 wherein the upper surface of the bottom plate comprises a central flat portion, a first lateral portion and a second lateral portion, each of which is angled in relation to the central flat portion so that both the first and second latera portions extend downwardly from the central flat portion.

9. A task reminding device comprising:
A housing having a top surface, a bottom surface and at least one side wall interconnecting the top surface and bottom surface;
A cavity formed between the top surface and bottom surface;
A channel disposed in the top surface and extending along a portion of the top surface in a longitudinal direction;
A plurality of slots formed in the top surface that extend perpendicularly to the channel wherein each of the plurality of slots includes a left slot and a right slot;
A moveable stylus having a lower portion disposed within the cavity and upper portion that extends above the top surface, wherein the stylus is moveable between the central channel and the plurality of slots; and
Whereby a user may record the completion of a task by moving the stylus to a predetermined slot within the plurality of slots.

10. The device of claim 9 further comprising a plurality of day indicators, each corresponding to one of the plurality of slots and a plurality of time indicators, each corresponding to the one of the plurality of slots.

11. The device of claim 10 wherein the plurality of slots includes a left slot and a right slot and wherein the plurality of time indicators includes a first time indicator corresponding to the left slot and a second time indicator corresponding to the right slot.

12. The device of claim 9 wherein the lower portion of the stylus has a width that is greater than the width of the central channel and the width of each of the plurality of slots.

13. The device of claim 9 further comprising a plurality of tabs formed in the bottom surface, each of the plurality of tabs is capable of being depressed and further having an unengaged state where an upper portion of the tab protrudes above the bottom surface and an engaged state where the lower portion of the stylus depresses the tab.

14. The device of claim 13 wherein the lower portion of the stylus includes an indention that is adapted to receive a portion of the tab when the tab is in the engaged state.

15. The device of claim 9 wherein the bottom surface comprises a central flat portion, a first lateral portion and a second lateral portion, each of which is angled in relation to the central flat portion so that both the first and the second lateral portions extend downwardly from the central flat portion.

16. A task reminding device comprising:
A housing having a top surface, a bottom surface and at least one side wall interconnecting the top surface and bottom surface;
A moveable stylus having a lower portion disposed within the housing and upper portion that extends outside of the housing, wherein the stylus is moveable in a first longitudinal direction, a second longitudinal direction that is opposite of the first direction, a third latitudinal direction that is perpendicular to the first longitudinal direction and a fourth latitudinal direction that is opposition of the third latitudinal direction,
at least four visual indicators disposed on the housing, each having a corresponding stylus resting point; and
Whereby a user may record the completion of a task by moving the stylus in at least one of the first longitudinal direction, second longitudinal direction, third latitudinal direction and fourth latitudinal direction to a predetermined resting point corresponding to one of the at least four visual indicators.

17. The device of claim 16 wherein the at least four visual indicators include at least one day indicator and at least one time indicator.

18. The device of claim 16 further comprising a central channel disposed in the top surface and extending along a central axis and a plurality of slots formed in the top surface that extend perpendicularly to the central channel wherein each of the plurality of slots includes a left slot and a right slot.

19. The device of claim 18 further comprising a first time indicator corresponding to the left slot and a second time indicator corresponding to the right slot.

20. The device of claim 16 further comprising a plurality of tabs formed in the bottom surface, each of the plurality of tabs corresponds to at least one of the stylus resting points and each of the plurality of tabs is capable of being depressed and further having an unengaged state where an upper portion of the tab protrudes above the bottom surface and further having an engaged state where the lower portion of the stylus depresses the tab.
